(19) United States
(12) Patent Application Publication
(10) Pub. No.: US 2022/0012673 A1
(43) Pub. Date: Jan. 13, 2022

(54) MAINTAINING STATUS INFORMATION FOR CUSTOMER-SUPPORT AGENTS ACROSS MULTIPLE CHANNELS

(71) Applicant: Zendesk, Inc., San Francisco, CA (US)

(72) Inventors: Elaine O'Carroll, Dublin (IE); Alberto Gregoris Herrero, Dublin (IE); Anne H.A. Brouwer, Citywest Village (IE); Volkan Akdugan, Dublin (IE); Chaminda Peiris, Arklow (IE)

(73) Assignee: Zendesk, Inc., San Francisco, CA (US)

(21) Appl. No.: 16/927,698

(22) Filed: Jul. 13, 2020

(51) Int. Cl. G06Q 10/06; G06Q 10/10; G06Q 30/00; G06F 11/07; G06F 16/2458

(52) U.S. Cl. CPC G06Q 10/063114; G06Q 10/107; G06Q 10/105; G06Q 30/0185; G06F 16/2474; G06F 11/0727; G06F 11/0751; G06F 11/0769; G06Q 30/016

(57) ABSTRACT

The disclosed embodiments relate to a system that maintains status information for customer-service agents in an online customer-support system. During operation, the system receives a request to update status information for a customer-service agent, wherein the request is received at an agent status keeper (ASK) service that provides a centralized repository for status information for customer-service agents, which can be accessed from multiple channels associated with separately siloed products. In response to the request, the system sends a message corresponding to the request to an inbox for an agent actor that operates on status information for the customer-service agent. While processing the message, the agent actor validates an assumed version number for the request. If the validation is successful, the agent actor commits the update by persisting one or more events produced by processing the request, and also publishes the one or more events to an associated publish/subscribe channel.

### BACKGROUND

### Field

The disclosed embodiments generally relate to the design of computer-based customer-support systems. More specifically, the disclosed embodiments relate to the design of a customer-support system that maintains status information for customer-support agents across multiple channels, such as chat, talk and email, which are associated with separately siloed products.

### Related Art

As electronic commerce continues to proliferate, customers are beginning to use online customer-support systems to help resolve problems, and to obtain information related to various products and services. These online customer-support systems are designed to help customers by: providing helpful information to the customers; or facilitating interactions with customer-support agents. When designed properly, these online customer-support systems can automate many customer-support interactions, thereby significantly reducing a company's customer-support costs.

In online customer-support systems, it is often advantageous for a customer to have a conversation with a customer-support agent to help resolve a customer's problem. To assign customer requests to agents efficiently, it is necessary to be able to quickly determine each agent's status. For example, a customer-support system might seek to assign a customer request to an agent who is online and is not presently engaged in a call.

However, it can be challenging to design a service that provides agent status information at the scale and speed required by many customer-support systems. For example, a large customer-support system can potentially be responsible for routing customer requests to thousands of customer-support agents. Moreover, each of these customer-support agents can potentially change their status 10 to 15 times an hour, and all of these changes need to be recorded. At the same time, the customer-support system may be processing thousands of queries a second, wherein each query requests a list of agents with a given status in order to make routing decisions. All of these queries need to be processed by evaluating agent status information in real time.

Hence, what is needed is a system that maintains status information for customer-support agents in a manner that facilitates frequent updates and a large volume of queries.

### SUMMARY

The disclosed embodiments relate to a system that maintains status information for customer-service agents in an online customer-support system. During operation, the system receives a request to update status information for a customer-service agent, wherein the request is received at an agent status keeper (ASK) service that provides a centralized repository for status information for customer-service agents, which can be accessed from multiple channels associated with separately siloed products. In response to the request, the system sends a message corresponding to the request to an inbox for an agent actor that operates on status information for the customer-service agent. While processing the message, the agent actor validates an assumed version number for the request. If the validation is successful, the agent actor commits the update by persisting one or more events produced by processing the request, and also publishes the one or more events to an associated publish/subscribe channel.

In some embodiments, the status information for the customer-service agent comprises: a current state for the agent, which indicates whether the agent is online or has another status; and a set of work items that have been assigned to the agent.

In some embodiments, the separately siloed products can include: a talk product; a chat product; a support product; and an email product.

In some embodiments, while validating the assumed version number, the agent actor compares a current version number stored in a record for the customer-service agent against the assumed version number, which was received along with the request. Next, if the current version number matches the expected version number, the agent actor validates the assumed version number.

In some embodiments, while committing the request, the agent actor increments the current version number for the customer-service agent, which is stored in a record for the customer-service agent.

In some embodiments, if the validation was not successful, the system responds to the request with an error message and the current version number to facilitate retrying the request.

In some embodiments, while persisting the one or more events, the system stores the one or more events along with associated sequence numbers to a journal.

In some embodiments, the system additionally takes a snapshot of a set of latest entries in the journal and separately stores the snapshot.

In some embodiments, the publish/subscribe channel is monitored by event processors that are subscribed to the channel. When an event processor receives an incoming event on the channel, the event processor checks a sequence number for the event against an expected sequence number maintained by the event processor to determine whether the event processor has missed any events. If the event processor has missed any events, the event processor performs a query to recover the missed events, and processes the missed events in sequential order before processing the incoming event.

In some embodiments, the system additionally receives a request to retrieve the status information for the customer-service agent. In response to the request, the system makes an application programming interface (API) call to retrieve the status information for the customer-service agent, and then responds to the request with the retrieved status information.

In some embodiments, the system additionally receives a request to retrieve a view on a collection of customer-service agents. In response to the request, the system makes API calls to retrieve status information for the collection of customer-service agents, and then responds to the request with the retrieved status information.

In some embodiments, the system additionally performs operations to facilitate sharding accounts and customer-service agents over multiple computing nodes to prevent hotspots, increase scalability and facilitate reliability.

### BRIEF DESCRIPTION OF THE FIGURES

FIG. 1 illustrates a computing environment, which includes an application and an associated customer-support system, in accordance with the disclosed embodiments.

FIG. 2 illustrates the structure of the customer-support system in accordance with the disclosed embodiments.

FIG. 3A illustrates an exemplary use case involving an ASK service in accordance with the disclosed embodiments.

FIG. 3B presents a table illustrating agent status information of the example in FIG. 3A in accordance with the disclosed embodiments.

FIG. 4 presents a sequence diagram for processing a request to update status information for a customer-service agent in accordance with the disclosed embodiments.

FIG. 5 presents a flow chart illustrating a process for updating status information for a customer-support agent in accordance with the disclosed embodiments.

FIG. 6 presents a flow chart illustrating a process for retrieving status information for a customer-support agent in accordance with the disclosed embodiments.

FIG. 7 presents a flow chart illustrating a process for retrieving a view on a collection of customer-service agents in accordance with the disclosed embodiments.

FIG. 8 presents a flow chart illustrating how an event processor processes an incoming event from a publish/subscribe channel in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Discussion

The disclosed embodiments relate to the design of an agent status keeper (ASK) service, which provides a reliable, scalable, performant, low-latency mechanism for storing status information for customer-service agents. This ASK service includes no business logic, but maintains the agent status information as a single source of truth across multiple channels, and in doing so provides a real-time view of agent status information across multiple products. The status information for a given customer-service agent can include: (1) a current state for the agent, which for example can indicate whether the agent is “online,” “offline” or “away;” and (2) a set of work items that have been assigned to the agent, which for example can specify that the agent has been assigned “1 phone call and 2 visitor chats.”

The ASK service also provides an API interface that enables products to: (1) write custom agent statuses in a manner that scales to handle thousands of such writes per second; and (2) dynamically query information about agents and their statuses spanning multiple products in real-time at up to thousands of requests per second. The ASK service also provides an asynchronous interface for the products to listen on based on an “event stream,” which is populated with agent status events associated with changes in agent status.

The ASK service additionally provides a remote procedure call (RPC) API (such as Google's gRPC), which can be accessed by products or services written in different programming languages. Note that in gRPC, a client application can directly call a method on a server application on a different machine as if it were a local object, making it easier to create distributed applications and services. These RPC APIs are reserved for real-time commands and querying, for example to decide which agent to route a work item to. All other requirements can be served asynchronously through an event bus, thereby not overwhelming the ASK service with real-time requests.

The disclosed system is constructed so that upon a successful update of agent status information, the system transmits an associated event on an event bus. This can be facilitated through use of event sourcing and CQRS design patterns. In event sourcing, instead of storing the current state of a system, the system only stores events that led up to that state. To get the current state, the system can “replay” the events in memory. CQRS design patterns provide separate classes for writing data and reading data. This makes it possible to have separate models for reading and writing, which facilitates optimizations for faster reads and writes.

The disclosed embodiments also make use of an “actor model,” wherein each customer-service agent is mapped to an actor instance. Within an actor model, the state of an actor can only be changed by messages, wherein messages for each actor are collected using an inbox and are processed in first-in-first-out order. Therefore, actors can only affect each other through messages, which means there is no need to use a locking system, which can slow down writes significantly.

A key feature of our system is how it deals with multiple concurrent updates to an agent. Consider an example where two products using the ASK service realize that an agent is available to process a work item. If both products submit a work item to the agent simultaneously, the ASK service will ensure that only one work item request is granted to the agent, and an error message is sent to the other product. This is accomplished through use of an optimistic locking technique for agents, which is implemented using “version numbers” for each actor. Any proposed change to an agent's status is based on an “assumed version number” associated with that agent's status. If the assumed version number does not match the current version number for the agent's status, this means another actor has changed the agent's status and the assumed version number is not valid. In this case, the sender will receive an error message along with the current version number for the agent's status to enable the sender to try again.

The RPC requests from the products include: (1) commands to retrieve the current state of an actor representing an agent, or to retrieve a view on a collection of agents; and (2) commands to mutate the state of an agent. A mutation on an agent will result in an event that stores the difference caused by the mutation. This event is stored with a serial number in a journal that is located in a database, such as a NoSQL™ database.

Snapshots of the events are taken and stored separately. These snapshots can be used to update the actor to a specific version without having to examine all of the events. This also allows us to delete events prior to the snapshot from the storage, which facilitates reducing database storage volume.

When an event is successfully stored in the database, the event is also propagated to different event processor stream actors through an event bus. This process makes use of serial numbers, which make it possible for event processors to determine a location where they last successfully processed an event in the event stream. By doing so, the system guarantees that in case of crashes, the application will always be able to recover to the last correct state. This also makes it possible to process events starting from the last valid position in the event storage before forwarding them to the event bus. In this way, we can guarantee that when an RPC command has been successfully processed, the corresponding event will be propagated through an event bus for asynchronous processing by the products.

In some embodiments, agents and their accounts are sharded (for example through use of an Akka™ cluster) to achieve load-balancing and resilience. By sharding different accounts and associated agents over multiple nodes in a cluster, the system can: (1) prevent hotspots for accounts with a large number of agents; (2) increase the number of nodes in the cluster based on resource requirements; (3) use the cluster to automatically perform failover when a node becomes effectively offline; and (4) handle cloud computing system failures by spreading a cluster over multiple cloud computing system zones.

### Computing Environment

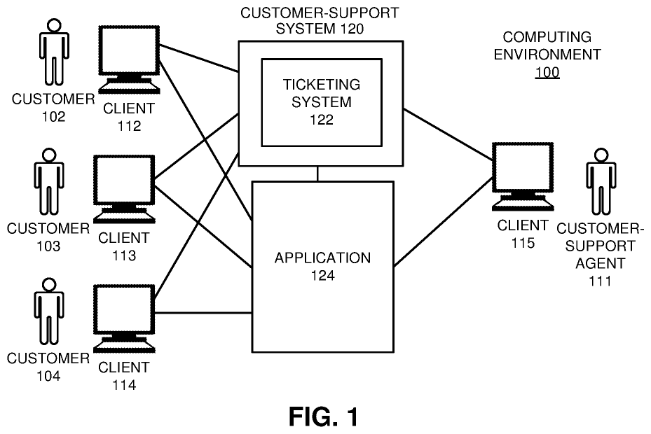

Before discussing the above-described ASK service in more detail, we first describe an exemplary computing environment in which it operates. FIG. 1 illustrates a computing environment that facilitates customer-support conversations. At the highest level, computing environment 100 includes an application 124 and a customer-support system 120. Within computing environment 100, a number of customers 102-104 interact with application 124 through client computer systems 112-114, respectively. Application 124 is provided by an organization, such as a commercial enterprise, to enable customers 102-104 to perform various operations associated with the organization, or to access one or more services provided by the organization. For example, application 124 can include online accounting software that customers 102-104 can access to prepare and file tax returns online. In another example, application 124 provides a commercial website for selling sporting equipment. Note that application 124 can be hosted on a local or remote server.

If customers 102-104 have problems with or questions about application 124, they can access customer-support system 120 to obtain help dealing with issues, which can include various problems and questions. For example, a user of accounting software may need help using a feature of the accounting software, or a customer of a website that sells sporting equipment may need help cancelling an order that was erroneously entered. This help may be provided by a customer-support agent 111 who operates a client computing system 115 and interacts with customers 102-104 through customer-support system 120. This help may also involve automatically suggesting helpful articles that the customer can read to hopefully resolve the problem or question. Note that customer-support agent 111 can access application 124 (either directly or indirectly through customer-support system 120) to help resolve an issue.

In some embodiments, customer-support system 120 is not associated with computer-based application 124, but is instead associated with another type of product or service that is offered to a customer. For example, customer-support system 120 can provide assistance with a product, such as a television, or with a service such as a package-delivery service.

Customer-support system 120 organizes customer issues using a ticketing system 122, which generates tickets to represent each customer issue. Ticketing systems are typically associated with a physical or virtual “help center” (or “help desk”) for resolving customer problems. Ticketing system 122 comprises a set of software resources that enable a customer to resolve an issue. Specific customer issues are associated with abstractions called “tickets,” which encapsulate various data and metadata associated with the customer requests to resolve an issue. (Within this specification, tickets are more generally referred to as “customer requests.”) An exemplary ticket can include a ticket identifier and information (or links to information) associated with the problem. For example, this information can include: (1) information about the problem; (2) customer information for one or more customers who are affected by the problem; (3) agent information for one or more customer-support agents who are interacting with the customer; (4) email and other electronic communications about the problem (which, for example, can include a question posed by a customer about the problem); (5) information about telephone calls associated with the problem; (6) timeline information associated with customer-support interactions to resolve the problem, including response times and resolution times, such as a first reply time, a time to full resolution and a requester wait time; and (7) effort metrics, such as a number of communications or responses by a customer, a number of times a ticket has been reopened, and a number of times the ticket has been reassigned to a different customer-support agent.

The structure of customer-support system 120 is described in further detail below.

### Customer-Support System

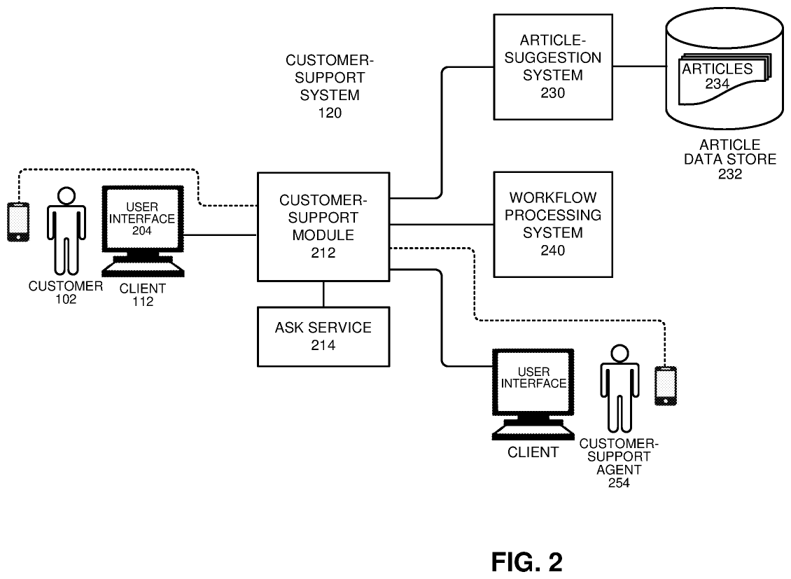

FIG. 2 illustrates how a customer 102 interacts with customer-support system 120 in accordance with the disclosed embodiments. During operation, the customer 102 who has an issue with a product or a service associated with application 124, interacts with customer-support system 120 through a user interface 204 in a client system 112. During this process, customer 102 submits a request to customer-support system 120 to obtain help with the issue, thereby initiating an automated customer-support conversation.

The request from customer 102 is directed to a customer-support module 212 within customer-support system 120. Customer-support module 212 can trigger various responsive customer-support actions, which will hopefully resolve the customer's issue. For example, customer-support module 212 can cause customer 102 to receive one or more helpful articles from an article-suggestion system 230 to facilitate resolving the customer's issue. During this process, article-suggestion system 230 obtains the one or more helpful articles from a set of help center articles 234 contained in an article data store 232.

Customer-support module 212 can alternatively trigger a predefined workflow from workflow processing system 240 to help resolve the customer's issue. Note that a predefined workflow orchestrates a sequence of interactions between the system and the customer to accomplish a given task, such as issuing a refund. For example, the predefined workflow can be associated with one or more of the following: obtaining status information for an order; changing a delivery address for an order; issuing a refund for an order; issuing an exchange for an order; resetting the customer's password; updating details of the customer's account; and canceling the customer's account.

Customer-support module 212 can also facilitate a customer-support conversation between customer 102 and a human customer-support agent 254 to help resolve the customer's issue. During this process, customer-support module 212 can make calls to ASK service 214 to identify an appropriate customer-support agent as is described in more detail below. Note that the customer-support conversation can take place through a number of channels, such as chat, talk or email.

### Example

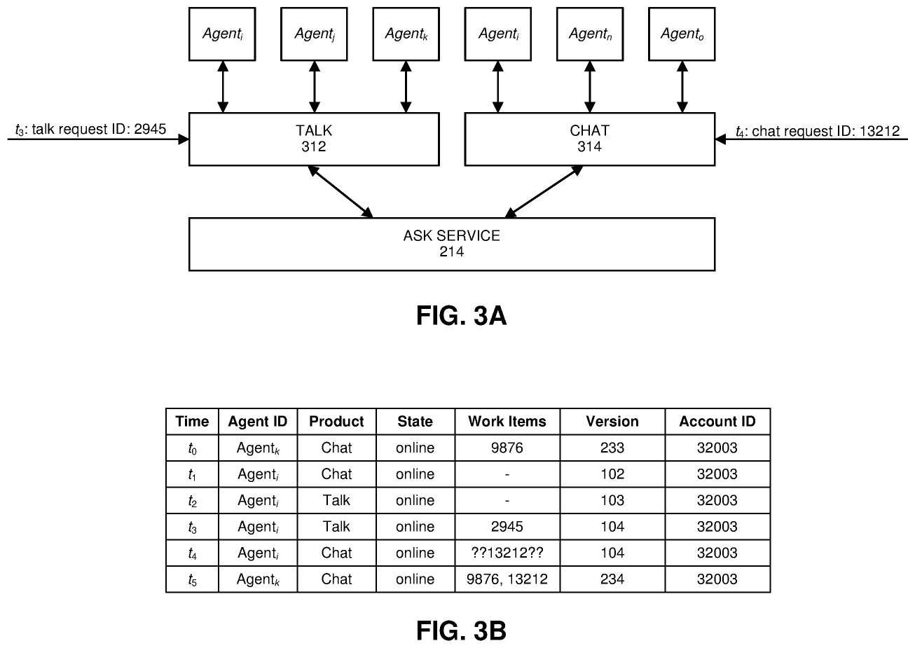

FIG. 3A illustrates an exemplary use case involving an ASK service 214 in accordance with the disclosed embodiments. As illustrated in FIG. 3A, a talk product 312 interacts with customer-service agents Agentᵢ, Agentⱼ and Agentₖ while a chat product 314 interacts with customer-service agents Agentᵢ, Agentₙ and Agentₒ. To facilitate these interactions, chat product 312 and talk product 314 make calls to ASK service 214 to obtain status information for a pool of potential customer-service agents. Ask service 214 processes these calls with reference to a table of agent status information illustrated in FIG. 3B.

In the example illustrated in FIGS. 3A and 3B, at time t₃ talk product 312 receives a talk request with a work item 2945. Note that at time t₃, the table in FIG. 3B indicates that Agentᵢ has no current work items, so work item 2945 is assigned to Agentᵢ. Next, at time t₄ chat product 314 receives a chat request with a work item number 13212. The system first attempts to determine whether work item 13212 can be assigned to Agentᵢ. However, business logic in chat product 314 does not allow the assignment to Agentᵢ because Agentᵢ already has a talk work item. Hence, at time t₅, work item 13212 is instead assigned to Agentₖ. Note that Agentₖ already has a chat work item 9876. However, the business logic in chat product 314 allows a chat to be assigned to an agent who already has a chat work item.

### Processing a Request to Update Status Information

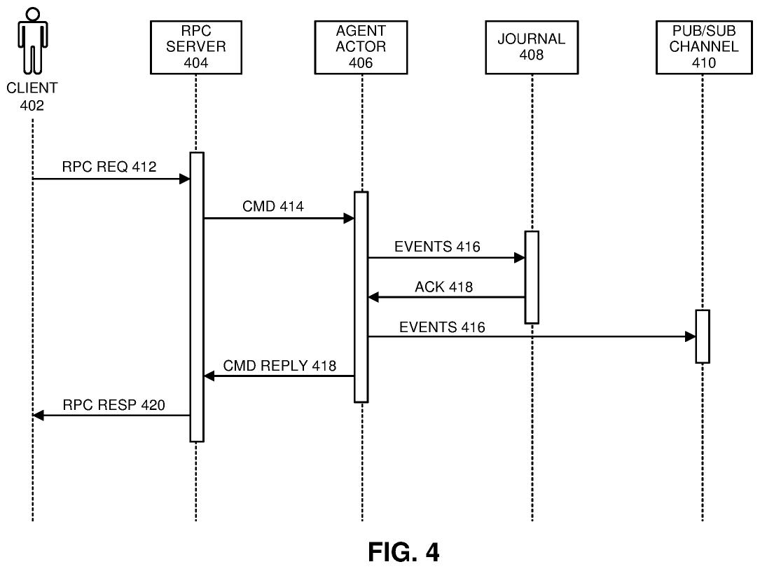

FIG. 4 presents a sequence diagram illustrating processing of a request to update status information for a customer-service agent in accordance with the disclosed embodiments. At the start of this process, a client 402 makes an RPC request 412, which involves an update to status information for a customer-service agent, to RPC server 404. In response to the request, RPC server 404 sends a corresponding command 414 to an agent actor 406 associated with the customer-service agent. Agent actor 406 first validates an assumed version number for the request (as is described in further detail below) and processes the command to generate events 416, which are sent to a journal 408. After the events are committed to journal 408 (and an associated snapshot is taken) journal 408 sends an acknowledgment 418 back to agent actor 406. After, acknowledgment 418 is received by agent actor 406, agent actor 406 sends the events 416 to publish/subscribe channel 410. Next, agent actor 406 sends a command reply 418 back to RPC server 404. This causes RPC server 404 to send an RPC response 420 back to client 402 thereby completing the process.

### Performing Operations on Status Information

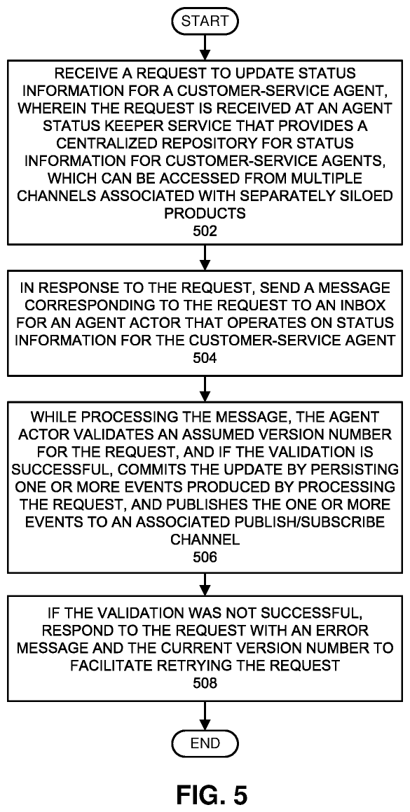

FIG. 5 presents a flow chart illustrating a process for updating status information for a customer-support agent in accordance with the disclosed embodiments. During operation, the system receives a request to update status information for a customer-service agent, wherein the request is received at an agent status keeper service that provides a centralized repository for status information for customer-service agents, which can be accessed from multiple channels associated with separately siloed products (step 502). In response to the request, the system sends a message corresponding to the request to an inbox for an agent actor that operates on status information for the customer-service agent (step 504). While processing the message, the agent actor validates an assumed version number for the request, and if the validation is successful, commits the update by persisting one or more events produced by processing the request, and publishes the one or more events to an associated publish/subscribe channel (step 506). If the validation was not successful, the agent actor responds to the request with an error message and the current version number to facilitate retrying the request (step 508).

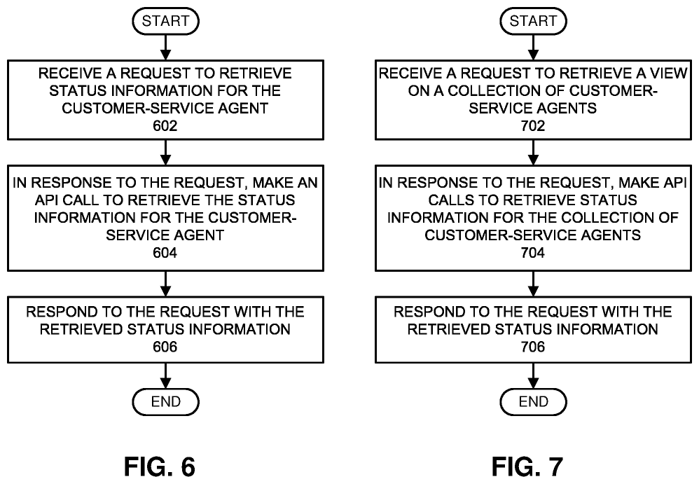

FIG. 6 presents a flow chart illustrating a process for retrieving status information for a customer-support agent in accordance with the disclosed embodiments. During this process, the system receives a request to retrieve the status information for the customer-service agent. In response to the request, the system makes an API call to retrieve the status information for the customer-service agent (step 604), and responds to the request with the retrieved status information (step 606).

FIG. 7 presents a flow chart illustrating a process for retrieving a view on a collection of customer-service agents in accordance with the disclosed embodiments. During this process, the system receives a request to retrieve a view on a collection of customer-service agents (step 702). In response to the request, the system makes API calls to retrieve status information for the collection of customer-service agents (step 704), and responds to the request with the retrieved status information (step 706).

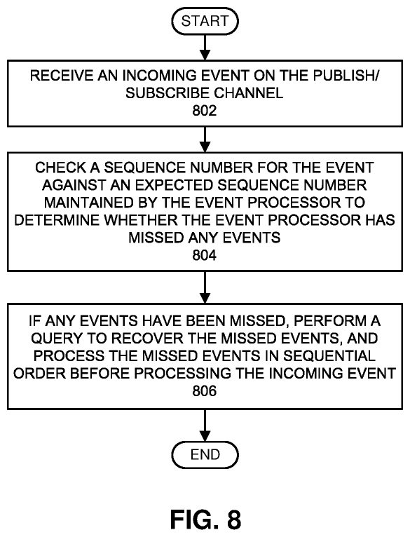

FIG. 8 presents a flow chart illustrating how an event processor processes an incoming event from the publish/subscribe channel in accordance with the disclosed emodiments. During operation, the publish/subscribe channel is monitored by event processors that are subscribed to the channel. When an event processor receives an incoming event on the publish/subscribe channel (step 802), the event processor checks a sequence number for the event against an expected sequence number maintained by the event processor to determine whether the event processor has missed any events (step 804). If the event processor has missed any events, the event processor performs a query to recover the missed events, and processes the missed events in sequential order before processing the incoming event (step 806).

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for maintaining status information for customer-service agents, the method comprising:
receiving a request to update status information for a customer-service agent, wherein the request is received at an agent status keeper (ASK) service that provides a centralized repository for status information for customer-service agents, which can be accessed from multiple channels associated with separately siloed products; and
in response to the request, sending a message corresponding to the request to an inbox for an agent actor that operates on status information for the customer-service agent;
wherein the agent actor processes the message by,
validating an assumed version number for the request, and
if the validation is successful, committing the update by persisting one or more events produced by processing the request, and publishing the one or more events to an associated publish/subscribe channel.

2. The method of claim 1, wherein the status information for the customer-service agent comprises:
a current state for the agent, which indicates whether the agent is online; and
a set of work items that have been assigned to the agent.

3. The method of claim 1, wherein the agent actor validates the assumed version number by:
comparing a current version number stored in a record for the customer-service agent against the assumed version number, which was received along with the request; and
validating the assumed version number if the current version number matches the expected version number.

4. The method of claim 3, wherein committing the request involves incrementing the current version number for the customer-service agent, which is stored in the record for the customer-service agent.

5. The method of claim 1, wherein if the validation was not successful, the method further comprises responding to the request with an error message and the current version number to facilitate retrying the request.

6. The method of claim 1, wherein persisting the one or more events involves storing the one or more events along with associated sequence numbers to a journal.

7. The method of claim 6, wherein the method further comprises taking a snapshot of a set of latest entries in the journal and separately storing the snapshot.

8. The method of claim 1,
wherein the publish/subscribe channel is monitored by event processors that are subscribed to the channel; and
wherein when an event processor receives an incoming event on the channel, the event processor,
checks a sequence number for the event against an expected sequence number maintained by the event processor to determine whether the event processor has missed any events, and
if the event processor has missed any events, performs a query to recover the missed events, and processes the missed events in sequential order before processing the incoming event.

9. The method of claim 1, wherein the method further comprises:
receiving a request to retrieve the status information for the customer-service agent;
in response to the request, making an application programming interface (API) call to retrieve the status information for the customer-service agent; and
responding to the request with the retrieved status information.

10. The method of claim 1, wherein the method further comprises:
receiving a request to retrieve a view on a collection of customer-service agents;
in response to the request, making API calls to retrieve status information for the collection of customer-service agents; and
responding to the request with the retrieved status information.

11. The method of claim 1, wherein the method performs operations to facilitate sharding accounts and customer-service agents across multiple computing nodes to prevent hotspots, increase scalability and facilitate reliability.

12. The method of claim 1, wherein the separately siloed products include one or more of: a talk product; a chat product; a support product; and an email product.

13. A non-transitory computer-readable storage medium storing instructions that when executed by a computer cause the computer to perform a method for maintaining status information for customer-service agents, the method comprising:
receiving a request to update status information for a customer-service agent, wherein the request is received at an agent status keeper (ASK) service that provides a centralized repository for status information for customer-service agents, which can be accessed from multiple channels associated with separately siloed products; and
in response to the request, sending a message corresponding to the request to an inbox for an agent actor that operates on status information for the customer-service agent;
wherein the agent actor processes the message by,
validating an assumed version number for the request, and
if the validation is successful, committing the update by persisting one or more events produced by processing the request, and publishing the one or more events to an associated publish/subscribe channel.

14. The non-transitory computer-readable storage medium of claim 13, wherein the status information for the customer-service agent comprises:
a current state for the agent, which indicates whether the agent is online; and
a set of work items that have been assigned to the agent.

15. The non-transitory computer-readable storage medium of claim 13, wherein the agent actor validates the assumed version number by:
comparing a current version number stored in a record for the customer-service agent against the assumed version number, which was received along with the request; and
validating the assumed version number if the current version number matches the expected version number.

16. The non-transitory computer-readable storage medium of claim 15, wherein committing the request involves incrementing the current version number for the customer-service agent, which is stored in the record for the customer-service agent.

17. The non-transitory computer-readable storage medium of claim 13, wherein if the validation was not successful, the method further comprises responding to the request with an error message and the current version number to facilitate retrying the request.

18. The non-transitory computer-readable storage medium of claim 13, wherein persisting the one or more events involves storing the one or more events along with associated sequence numbers to a journal.

19. The non-transitory computer-readable storage medium of claim 18, wherein the method further comprises taking a snapshot of a set of latest entries in the journal and separately storing the snapshot.

20. The non-transitory computer-readable storage medium of claim 13, wherein the publish/subscribe channel is monitored by event processors that are subscribed to the channel; and
wherein when an event processor receives an incoming event on the channel, the event processor,
checks a sequence number for the event against an expected sequence number maintained by the event processor to determine whether the event processor has missed any events, and
if the event processor has missed any events, performs a query to recover the missed events, and processes the missed events in sequential order before processing the incoming event.

21. The non-transitory computer-readable storage medium of claim 13, wherein the method further comprises:
receiving a request to retrieve the status information for the customer-service agent; and
in response to the request, making an application programming interface (API) call to retrieve the status information for the customer-service agent; and
responding to the request with the retrieved status information.

22. The non-transitory computer-readable storage medium of claim 13, wherein the method further comprises:
receiving a request to retrieve a view on a collection of customer-service agents;
in response to the request, making API calls to retrieve status information for the collection of customer-service agents; and
responding to the request with the retrieved status information.

23. A system that maintains status information for customer-service agents in an online customer-support system, comprising:
at least one processor and at least one associated memory; and
a request-processing mechanism, which executes on the at least one processor, wherein during operation, the request-processing mechanism:
receives a request to update status information for a customer-service agent, wherein the request is received at an agent status keeper (ASK) service that provides a centralized repository for status information for customer-service agents, which can be accessed from multiple channels associated with separately siloed products; and
in response to the request, sends a message corresponding to the request to an inbox for an agent actor that operates on status information for the customer-service agent;
wherein while processing the message, the agent actor,
validates an assumed version number for the request, and
if the validation is successful, commits the update by persisting one or more events produced by processing the request, and publishes the one or more events to an associated publish/subscribe channel.

24. The system of claim 23, wherein the status information for the customer-service agent comprises:
a current state for the agent, which indicates whether the agent is online; and
a set of work items that have been assigned to the agent.

25. The system of claim 23, wherein while validating the assumed version number, the agent actor:
compares a current version number stored in a record for the customer-service agent against the assumed version number, which was received along with the request; and
validates the assumed version number if the current version number matches the expected version number.

26. The system of claim 25, wherein while committing the request, the agent actor increments the current version number for the customer-service agent, which is stored in the record for the customer-service agent.

27. The system of claim 23, wherein if the validation was not successful, the request-processing mechanism responds to the request with an error message and the current version number to facilitate retrying the request.

28. The system of claim 23, wherein while persisting the one or more events, the system stores the one or more events along with associated sequence numbers to a journal.

29. The system of claim 28, wherein the system additionally takes a snapshot of a set of latest entries in the journal and separately stores the snapshot.

30. The system of claim 29,
wherein the publish/subscribe channel is monitored by event processors that are subscribed to the channel; and
wherein when an event processor receives an incoming event on the channel, the event processor,
checks a sequence number for the event against an expected sequence number maintained by the event processor to determine whether the event processor has missed any events, and
if the event processor has missed any events, performs a query to recover the missed events, and processes the missed events in sequential order before processing the incoming event.

31. The system of claim 23, wherein the request-processing mechanism additionally:
receives a request to retrieve the status information for the customer-service agent;
in response to the request, makes an application programming interface (API) call to retrieve the status information for the customer-service agent; and
responds to the request with the retrieved status information.

32. The system of claim 23, wherein the request-processing mechanism additionally:
receives a request to retrieve a view on a collection of customer-service agents;
in response to the request, makes API calls to retrieve status information for the collection of customer-service agents; and
responds to the request with the retrieved status information.
